(19) United States
(12) Patent Application Publication
(10) Pub. No.: US 2006/0274253 A1
(43) Pub. Date: Dec. 7, 2006

(54) Conductive spacers for liquid crystal displays

(75) Inventors: Tang-Chieh Liu, Taichung City (TW); Bau-Jy Liang, Hsinchu City (TW); Ming-Kung Wu, Taichung County (TW); Yi-Fan Hsiao, Taichung County (TW); Ya-Wen Li, Taichung City (TW)

Correspondence Address: BIRCH STEWART KOLASCH & BIRCH, PO BOX 747, FALLS CHURCH, VA, 22040-0747, US

(73) Assignee: WINTEK CORPORATION

(21) Appl. No.: 11/143,432

(22) Filed: Jun. 3, 2005

(51) Int. Cl. G02F 1/1339

(52) U.S. Cl. 349/155

(57) ABSTRACT

A liquid crystal display (LCD) includes an upper board and a lower board that couple each other and form a space therebetween, a liquid crystal layer sandwiched between the upper board and the lower board and a plurality of spacers located in the space between the upper board and the lower board. The spacers are conductive so that the liquid crystal layer and the spacers form two equivalent parallel resistive paths to conduct the extra charges in the liquid crystals. When the LCD is subject to an external high static charge source, the static partial voltage found in the liquid crystal layer is reduced because of the lower equivalent parallel resistance, thus the damage and the interference on the liquid crystals in the liquid crystal layer caused by the external static charge source may be reduced.

### FIELD OF THE INVENTION

The present invention relates to a technique to reduce the partial voltage exerted from an external static charge source on the liquid crystal layer in liquid crystal displays (LCDs) to mitigate the damaging effect of the charges on the liquid crystals (LCs) such that the capability of the LCD to withstand high-voltage electrostatic charges will be enhanced.

### BACKGROUND OF THE INVENTION

For conventional LCD products exposed in an environment of high-voltage electrostatic charges, instantaneous injection of the charges would either cause burnout of the ITO circuits or make the LC cells (the pixels) malfunctioning. A guarding element or structure against electrostatic discharging (ESD) is necessary and usually found in designing the entire module. However, this approach usually results in the penalty of larger size for the modules or related parts, and hence a higher cost for products.

Several approaches have been proposed to diminish the damages from the electrostatic charges in LCD products. In U.S. Patent Publication No. 20020088629A1 entitled “Grounding device for a portable radio terminal”, a device which is connected with the RF part provides a ground path to the coupled upper board and lower board in the display module. Through the flexible print circuit (FPC) connecting the RF module and the LCD module, the electrostatic charges trapped in the LCD can be conducted to the ground and the damages caused by ESD can then be eliminated.

It is well known that the alignment of liquid crystal molecules is strongly affected by the applied electric field. By changing the consistence of the alignment scheme between the LCs and the polarization layers, the brightness/intensity of a pixel can be modulated through the exerted electric field. Since the LC molecules are affected by the electric field, the display quality will be deteriorated if there are trapped charges in the LC cells. This is still a serious issue not totally solved by conventional discharging approaches.

Efforts in finding new compositions for the LCs were also devoted by researchers. ROC Patent Publication No. 434310 entitled “Liquid crystal composition” disclosed a nematic liquid crystal including 1 to 10000 ppm of lariat ethers and some other similar compositions to achieve a resistivity about 1×10¹¹ Ω-cm to release the internal electrostatic charges in the LC layer.

The aforesaid references have tried to overcome the electrostatic charge problems by a special grounding device or uncommon materials. Both will result in a much higher cost in fabrication. In short, their disadvantages can be summarized as below:

1. Special shielding lines or discharging lines are added while the LCD adopts the scheme of guarding rings. These special lines will make the design of the interconnection layout more complicated. Even with a conductive layer coated on the entire outer surface of the board will also increase the fabrication cost.

2. In investigating new conductive structures against the electrostatic discharging effect will inevitably include some special materials in the LCs and a few conductive materials doped in the polyimide layers. This makes the structure more complicated, and also increases the manufacturing cost.

### SUMMARY OF THE INVENTION

To solve the aforesaid disadvantages, the primary object of the present invention is to make spacers conductive in the liquid crystal layer of a LCD in which the spacers originally provides a function of anchoring the upper and lower board and now also forms a conductive path to reduce the unwanted voltage built between the upper and lower sides of the liquid crystal layer. The capability of the modified LCD to withstand the static charge will be promoted.

Since the slightly leaky liquid crystals and the conductive spacers provide two equivalent resistors in parallel with each other, another object of the invention is to decrease the partial voltage exerted on the liquid crystal layer from the external high-voltage static charges by the smaller resistance formed by the liquid crystals and the spacers. The damage in the liquid crystal layer from the external static charge source is thereby reduced. The display quality and its reliability of the LCD panel can also be pertained.

This invention includes an upper board and a lower board that couple to each other. There forms a space between them. A liquid crystal layer is sandwiched between the upper and the lower boards. There are also a plurality of spacers to anchor the space between the upper and the lower boards. These spacers are not electrically connected to one another.

By means of the above construction set forth, the liquid crystals and the spacers in the liquid crystal layer play as two resistors that are coupled in parallel. The partial voltage found in the liquid crystal layer will be smaller so that the damaging effect of the external electrostatic charge source on the liquid crystals in the liquid crystal layer will be reduced. Therefore the display quality of the display panel may be pertained as desired and the capability of the LCD to withstand the electrostatic charge is enhanced.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a schematic view of the LCD according to the present invention.

FIG. 2 is a schematic view of another LCD according to the present invention.

FIG. 3 is an equivalent circuit diagram according to the present invention.

### DETAILED DESCRIPTION OF THE PREFERRED EMBODIMENTS

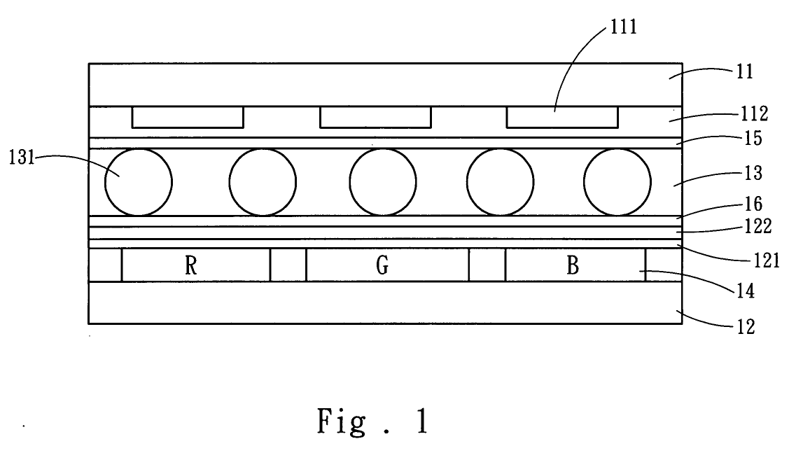

Please refer to FIG. 1, the fundamental manufacturing process of the LCD according to the invention is substantially same as that of the conventional LCD. The LCD of the invention includes an upper board 11 and a lower board 12 that couple to each other with a space interposed between them. The surfaces of the upper board 11 and the lower board 12 that face to each other have respectively transparent electrode layers 111 and 121 formed with a patterned pixel circuit, and insulation layers 112 and 122 covering the transparent electrode layers 111 and 121. On the surface of the transparent electrode layer 121 of the lower board 12, there is a color filter 14. On the surfaces of the insulation layers 112 and 122 that face to each other, there are respectively polyimides 15 and 16.

There is a liquid crystal layer 13 sandwiched between the upper board 11 and the lower board 12 and a plurality of spacers 131 located in the space between the upper board 11 and the lower board 12. The spacers 131 are conductive and are used to anchor the space between the upper board 11 and the lower board 12. Namely, the height of the spacers 131 is the height of the space between the upper board 11 and the lower board 12.

The spacers 131 are conductive (referring to FIG. 1), and may be selected from carbon black, carbon fibers, carbon filaments, carbon nanotubes, carbon fibers coated with metal, graphite coated with metal, glass fibers coated with metal, metal particles, stainless steel filaments and metal foils, or conductive polymers such as polyanilines (PANI), polypyrroles (PPy), poly-para-phenylenes (PPP), polythiophenes (PT), or metal oxide powders such as indium tin oxides (ITO) or indium zinc oxides (IZO).

The conductive spacers 131 are sprayed within an area surrounded by sealing framing resin on the board. In the later processes, liquid crystals are injected and the boards are compressed and sealed to form the liquid crystal layer 13 embedded with the conductive spacers 131. In the conventional techniques, the conductive materials are located in the sealing framing resin of the LCD to form conductive path between the upper and lower glass board as shown in FIG. 1. Adopted the invention, material types used in the LCD structure are reduced, and pollution and other impacts resulting from using too many types of materials are also decreased.

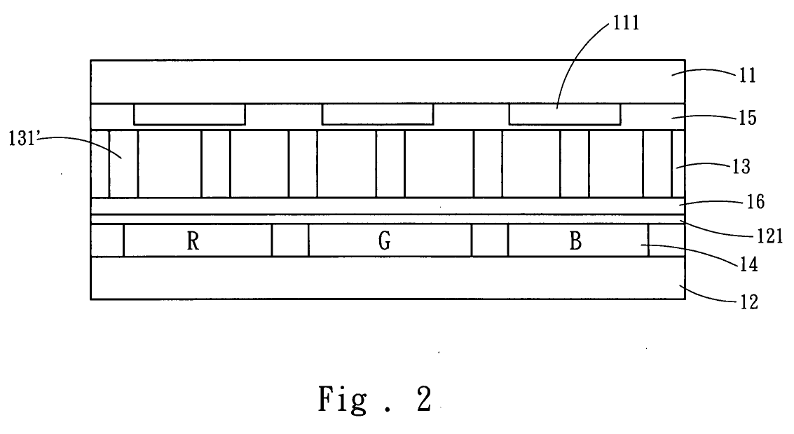

In order to prevent possible shorts between the electrodes of pixels, the spacers should be placed where the operation of the pixels will not be interfered. Referring to FIG. 2, the spacers 131′ of the invention are an electrically conductive polymer composite composition which may be etched easily. Hence the location of the spacers 131′ may be controlled. Therefore, the spacers 131′ may be formed on the upper surface of the required films on the lower board 12 by encasing the transparent electrode layers 111 and 121 with polyimides 15 and 16, and going through fabrication processes of exposing, developing and etching and the like.

The electrically conductive polymer composite composition may also be selected from thermoplastic polymers such as polyphenylene ethers, polyamides, polysiloxanes, polyesters, polyidmides, polyetherimides (PEI), polysulfides (PSU), polysulfones (PSF), polyether sulfones (PES), olefin polymers, polyurethanes, and polycarbonates; or thermosetting polymers such as polyepoxides, phenolic resins, polybisimaleimides, natural rubbers, synthetic rubbers, silicone gums and thermosetting polyurethanes; or photosensitive resins formed by mixtures of unsaturated functional groups and photosensitive multifunctional group single elements. Electrically conductive fillers are added to the aforesaid thermoplastic polymers, thermosetting polymers or photosensitive resins.

The electrically conductive filler may be selected from carbon blacks, carbon fibers, carbon filaments, carbon nanotubes, carbon fibers coated with metal, graphites coated with metal, glass fibers coated with metal, metal particles, stainless steel filaments, metal foils and metal powders; or conductive polymers such as polyanilines (PANI), polypyrroles (PPy), poly-para-phenylenes (PPP), polythiophenes (PT), or metal oxide powders such as indium tin oxides (ITO) or indium zinc oxides (IZO). Selection of the material and the proportion thereof may take into account of material characteristics and the partial voltage to be found in the liquid crystal layer 13.

The photosensitive spacers may also be formed in a desired pattern by exposing and developing techniques according to requirements, and be distributed on selected locations on the necessary films of the surface of the lower board 12 as shown in FIG. 2. Through this method, the dimension, quantity and lying location of the spacers 131′ may be adjusted as desired. The photosensitive spacers thus formed also can reduce leakage of light from the space boundary of liquid crystal layer and scrapping of the color filter.

The partial voltage principle of the parallel resistor circuit adopted in the invention is as follow:

Vi=Vs×Ri/Rs (where Vs is total voltage, Ri is the resistor i, Rs is total resistance, Vi is the partial voltage of the resistor i). When the resistance Ri is greater, the partial voltage found in the resistor also proportionally increases.

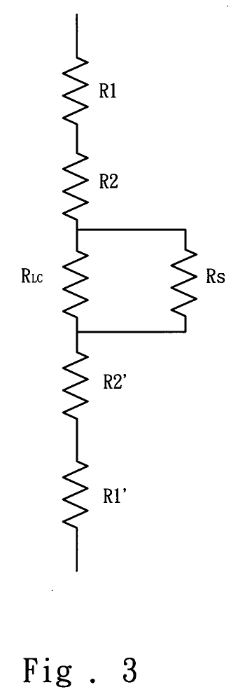

The upper and lower layers of the LCD can be seen as a plurality of equivalent resistors coupled in parallel (referring to FIG. 3). Assumed the liquid crystal layer 13 has an equivalent resistance RLC, where R2, R2′ represent the resistance of the upper and lower transparent board respectively, R1 and R1′ represent respectively the resistance of other necessary devices, such as the polarizer sheets, other than the upper and lower boards. The spacers 131 and 131′ of the invention form an equivalent parallel resistance Rs in the liquid crystal layer 13. Hence the equivalent resistance between the transparent upper and lower boards is RLC′=RLC//Rs<RLC. Refer to FIG. 3 for the equivalent resistance circuit. The partial voltage obtained in the liquid crystal layer 13 is reduced significantly. Thus the invention can reduce the voltage difference between the upper and lower sides of a liquid crystal box to prevent breakdown or damage in the liquid crystal layer caused by too much partial voltage difference between the upper side and lower side resulting from the static charge.

Use condition, materials and content proportion of the spacers 131 and 131′ may be adjusted according to the resistance of the liquid crystal layer to reduce the partial voltage as desired to withstand the static charge. The effect of bearing the static charge also may be altered according to special requirements such as the types, physical characteristics, adding proportion of the conductive substance, and the like.

While the preferred embodiments of the present invention have been set forth for the purpose of disclosure, modifications of the disclosed embodiments of the invention as well as other embodiments thereof may occur to those skilled in the art. Accordingly, the appended claims are intended to cover all embodiments which do not depart from the spirit and scope of the invention.

What is claimed is:

1. A liquid crystal display, comprising:
an upper board and a lower board corresponding to each other and having respectively a transparent electrode layer on a surface facing each other that has a patterned pixel circuit, and a space interposed therebetween;
a liquid crystal layer sandwiched between the upper board and the lower board; and
a plurality of conductive spacers located between the upper board and the lower board.

2. The liquid crystal display of claim 1, wherein the spacers are conductive materials.

3. The liquid crystal display of claim 2, wherein the conductive materials are selected from the group consisting of carbon blacks, carbon fibers, carbon filaments and carbon nanotubes.

4. The liquid crystal display of claim 2, wherein the conductive materials are selected from the group consisting of carbon fibers coated with metal, graphites coated with metal and glass fibers coated with metal.

5. The liquid crystal display of claim 2, wherein the conductive materials are selected from the group consisting of metal particles, stainless steel filaments and metal foils.

6. The liquid crystal display of claim 2, wherein the conductive materials are metal oxide.

7. The liquid crystal display of claim 2, wherein the conductive materials are conductive polymers.

8. The liquid crystal display of claim 7, wherein the conductive polymers are selected from the group consisting of polyanilines (PANI), polypyrroles (PPy), poly-para-phenylenes (PPP) and polythiophenes (PT).

9. A liquid crystal display, comprising:
an upper board and a lower board corresponding to each other and having respectively a transparent electrode layer on a surface facing each other that has a patterned pixel circuit, and a space interposed therebetween;
a liquid crystal layer sandwiched between the upper board and the lower board; and
a plurality of conductive spacers being an electrically conductive polymer composite composition located between the upper board and the lower board.

10. The liquid crystal display of claim 9, wherein the electrically conductive polymer composite composition is selected from the group consisting of thermoplastic polymers, thermosetting polymers and photosensitive resins that contain an electrically conductive filler.

11. The liquid crystal display of claim 10, wherein the thermoplastic polymers are selected from the group consisting of polyphenylene ethers, polyamides, polysiloxanes, polyesters, polyidmides, polyetherimides (PEI), polysulfides (PSU), polysulfones (PSF), polyether sulfones (PES), olefin polymers, polyurethanes and polycarbonates.

12. The liquid crystal display of claim 10, wherein the thermosetting polymers are selected from the group consisting of polyepoxides, phenolic resins, polybisimaleimides, natural rubbers, synthetic rubbers, silicone gums and thermosetting polyurethanes.

13. The liquid crystal display of claim 10, wherein the photosensitive resins are selected from mixtures of unsaturated functional groups and photosensitive multifunctional groups single elements.

14. The liquid crystal display of claim 10, wherein the electrically conductive filler is selected from the group consisting of carbon blacks, carbon fibers, carbon filaments and carbon nanotubes.

15. The liquid crystal display of claim 10, wherein the electrically conductive filler is selected from the group consisting of carbon fibers coated with metal, graphites coated with metal and glass fibers coated with metal.

16. The liquid crystal display of claim 10, wherein the electrically conductive filler is selected from the group consisting of conductive polymer filaments, metal particles, stainless steel filaments, metal foils and metal powders.

17. The liquid crystal display of claim 10, wherein the electrically conductive filler is a powder metal oxide.

18. The liquid crystal display of claim 10, wherein the electrically conductive filler is a conductive polymer.

19. The liquid crystal display of claim 18, wherein the conductive polymer is selected from the group consisting of polyanilines (PANI), polypyrroles (PPy), poly-para-phenylenes (PPP) and polythiophenes (PT).
